(19) United States
(12) Patent Application Publication
(10) Pub. No.: US 2006/0037242 A1
(43) Pub. Date: Feb. 23, 2006

(54) Device and method for fitting a sleeve around a pot plant

(76) Inventors: Henri Peter Herman Maria Verdeijen, Noordwijk (NL); Gerard Marie Van Egmond, Zwammerdam (NL)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/140,496

(22) Filed: May 27, 2005

(30) Foreign Application Priority Data
May 28, 2004 (NL) 1026297

(51) Int. Cl. A01G 9/02

(52) U.S. Cl. 47/72

(57) ABSTRACT

This plant is a pot plant, the pot of which is clamped while fitting the sleeve by clamping fingers that form the extension of at least three shells between which the plant of the pot plant is accommodated. As a result of the use of at least three shells unimpeded release of the plant can be achieved when the shells are flipped away. By moving the plant in this way the sleeve fitted externally on the shells is also positioned.

The present invention relates to a device for fitting a sleeve around a plant, comprising guide shells for accommodating a plant between them and taking a sleeve outside them, which shells can be moved relative to one another between a closed position in which the shells delimit a space for accepting a plant from a first direction from the introduction end of the shells and an open position for releasing the plant in a second direction from the release end of the shells when fitting said sleeve, wherein said second direction is in the extension of said first direction, there being at least three shells that can be moved relative to one another.

A device of this type is disclosed in EP 1 254 837. This publication describes placing a bunch of flowers in a sleeve. In contrast to a pot plant, the bottom end of such a bouquet is relatively flexible and movement in the second direction can easily take place. The device consists of a number of curved fingers that are made conical and in the closed position together delimit a conical space. As indicated, the plants concerned can easily be moved to some extent so that when the shells are moved a slight distance apart the plant can be moved along the shells or spoons in the downward direction.

The aim of the present invention is to be able to use the technique described in this patent for pot plants and more particularly for pot plants where plants are cultivated that are deformable or difficult to move or rapidly become damaged.

More particularly the aim of the present invention is to fix the position of the sleeves with respect to the pot plant in a more assured manner.

This aim is realised with the device described above in that the device has transport means for moving a sleeve over said shells in a direction opposed to said first and second direction.

According to the invention there are transport means for sliding the sleeve upwards onto the closed shells. There are various possibilities for this.

A first possibility consists in applying a series of rollers or belt that is pressed against the shell when the sleeve is taken up between them. Such a series of rollers preferably extends such that when they are driven the sleeve is pulled upwards onto the shells. Another possibility consists in gripping the sleeve and pulling it upwards. It is optionally possible to make slots in the shells for this purpose.

There is a great need for mechanisation of placing pot plants in a sleeve. More particularly, using the present invention it is possible to place in a sleeve plants in pots that are difficult to move or may not be moved because of damage. Kalanchoe is mentioned as an example. Such plants are difficult to place in sleeves. When this placement is carried out manually in accordance with the state of the art the capacity is approximately one third the capacity in the case of plants that are easy to place in a sleeve. By means of the present invention it is possible to provide pot plants of a wide range of plant varieties with sleeves at very high speeds.

Although the shells can be fitted such that they can be moved with respect to one another in any way known in the state of the art, such as movement thereof in a direction perpendicular to the direction of movement of the pot plant through the device, it is preferred that the shells are fitted on a frame in a pivoting manner. This pivot point is preferably close to the introduction end of the shell, that is to say close to the largest dimension thereof. After all, the need for an increase in cross-sectional surface area is least at that location. This applies in particular if the shells together delimit a cone. However, it must be understood that it is possible to define any other shape for the plant with the shells. Depending on said shape, the pattern of movement of the shells can be made pivoting, translational, etc.

According to a further advantageous embodiment the shells are, or the extension thereof is, provided with gripper means for gripping the pot. That is to say, firstly the pot is prevented from “dropping through” when the pot plant is introduced into the device. Moreover, by pulling the sleeve taut around the pot, the pot is prevented from moving upwards. The forces concerned are transmitted directly from the pot to the shells and do not run via the plant. As a result damage to the plant can be prevented. Secondly, the possibility of clamping the pot, as a result of which this is firmly positioned between the shells, is obtained in this way. If such clamping takes place in the extension of the shells, gripper fingers that grip the pot are preferably present. Gripping of the pot preferably takes place below the rim of the pot. This arrangement prevents the pot also being pulled upwards when the sleeve is pulled over the pot.

It must be understood that in the above and below directions such as upwards and downwards are regularly mentioned. This is merely an example. It is also possible to move the pot plants in the horizontal direction, but, especially if there is loose earth on the pot plant, it is preferred to carry out the various operations in the vertical direction.

According to a further advantageous embodiment of the invention, the movement of the pot plant in the shells is as far as possible carried out in a controlled manner. That is to say, there is no longer exclusive reliance on gravity by means of which pots are placed in the space delimited between the shells.

According to a first variant of the present invention this is achieved with first movement means that grip the pot plant when it enters the space delimited by the shells and then guide the pot in a positive manner through the shells until there is engagement between the pot and shells. As a result it is assured that the pot is in precisely the correct position and the movement thereof is not impeded by protruding parts of the plant.

According to a further embodiment of the invention there can be second movement means that present the pot plant above the shell parts and hold on to the pot until the first movement means become effective.

The sleeves preferably come from a store. Preferably such a store is arranged below the construction with shells so that, after they have been separated and opened by a movement in the lateral direction, the sleeves can immediately be placed on the shells upwards in the vertical direction.

In order to achieve a high speed when picking up pot plants and releasing them again when fitting sleeves, according to an advantageous embodiment at least part of the device described above is made so that it can move. More particularly, the various features are constructed as a carousel. This relates in particular to the part with the shells. This moves between an introduction station for a pot plant and a release station for the pot plant that has been provided with a sleeve in the meantime. With this arrangement the sleeves can come from a stationary station. It will be understood that a number of such assemblies consisting of shells one after the other can be arranged in a carousel, as a result of which a large number of pot plants can be moved successively past various stations.

The invention also relates to providing a pot plant with a sleeve, comprising introducing and enclosing said plant in a space between shells, fitting a sleeve over said shells and simultaneously removing said plant and said sleeve from said shells, wherein the plant is a pot plant, the pot of which is clamped during fitting of the sleeve.

According to a particular embodiment of this method the introduction and enclosure of said plant in said space takes place in a positively controlled manner.

The invention will be explained in more detail below with reference to an illustrative embodiment shown in the drawing. In the drawing:

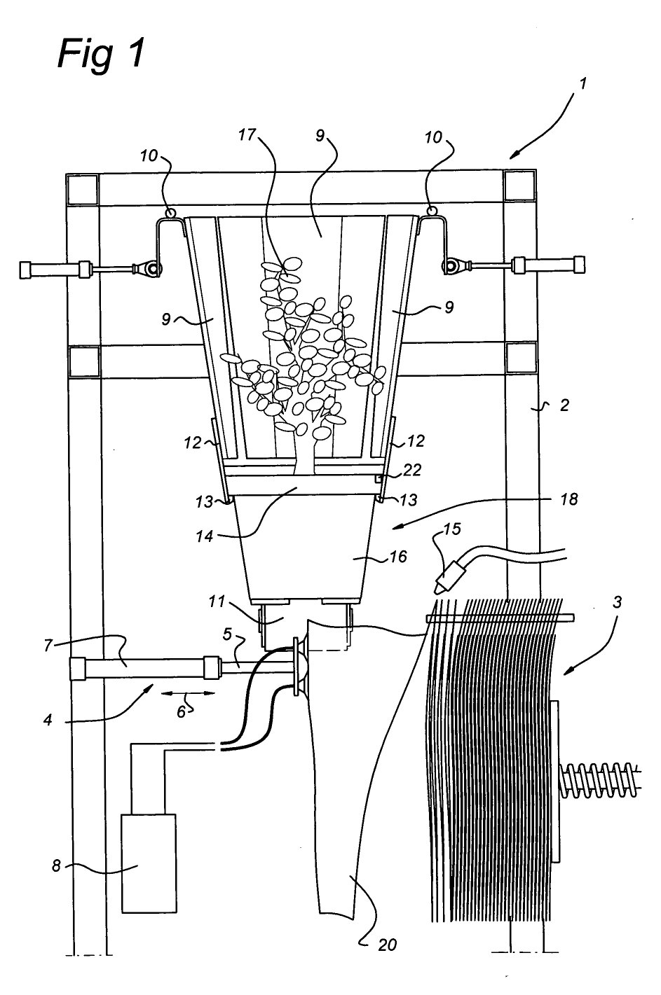

FIG. 1 shows the device according to the present invention diagrammatically in side view;

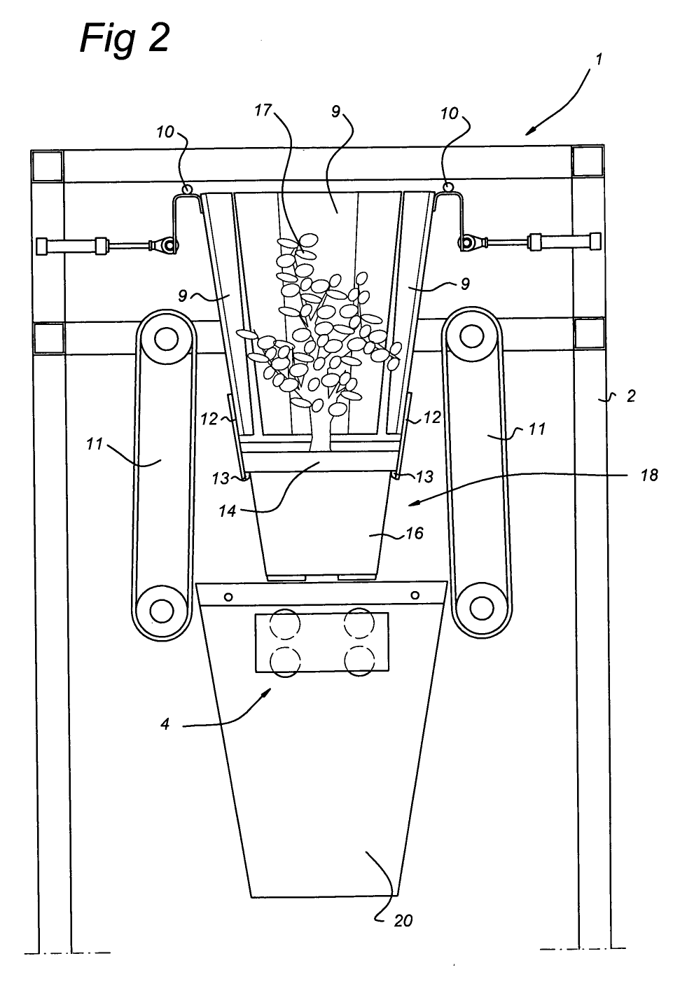

FIG. 2 shows the device according to FIG. 1 turned through 90°;

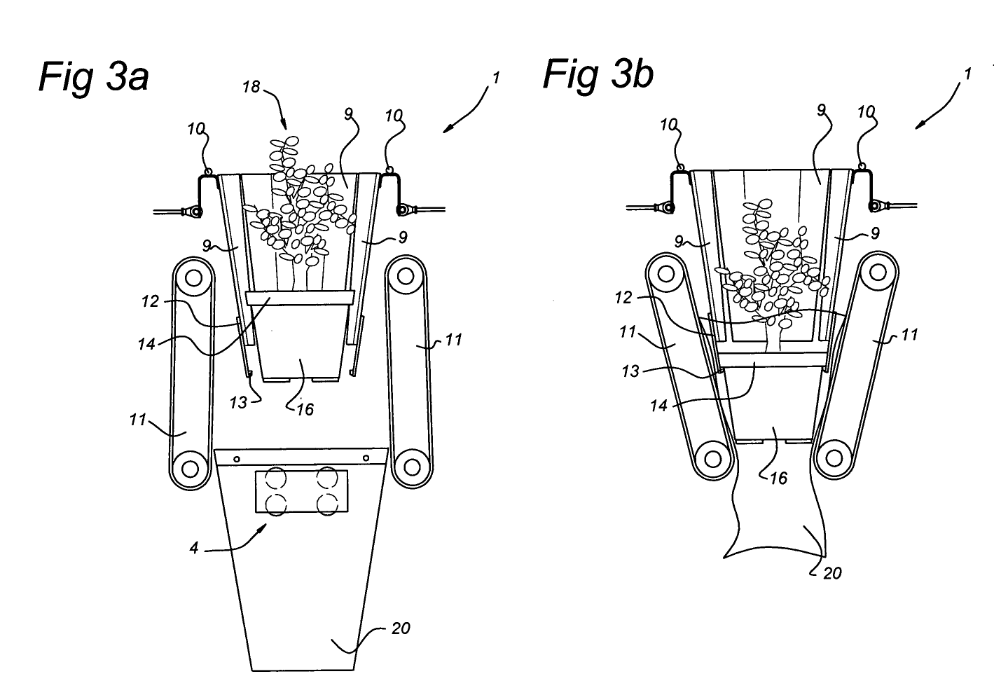

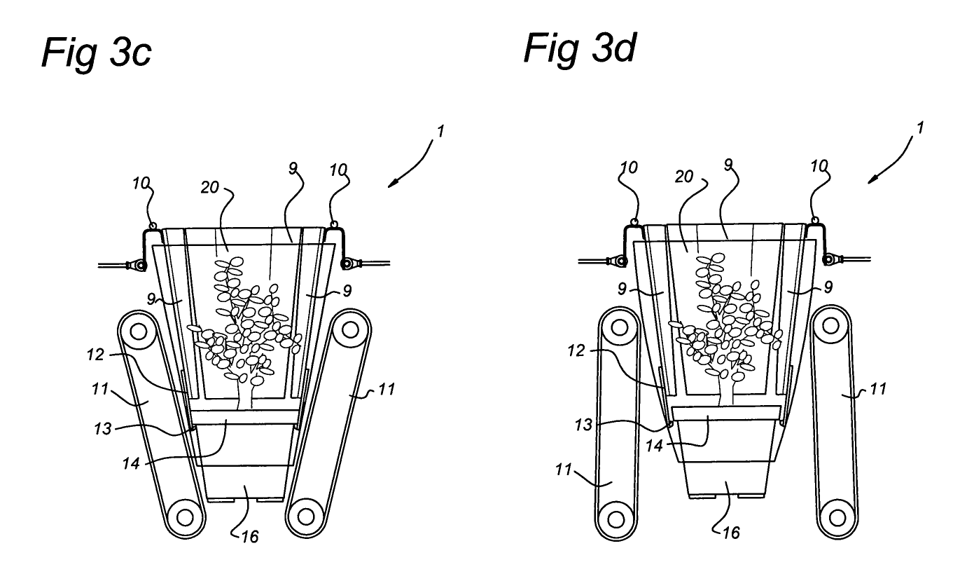

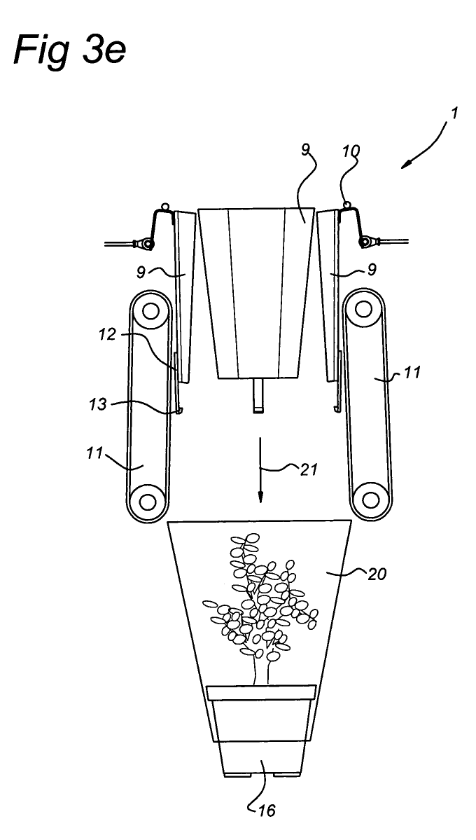

FIGS. 3a-e show the various stages for fitting a plant sleeve; and

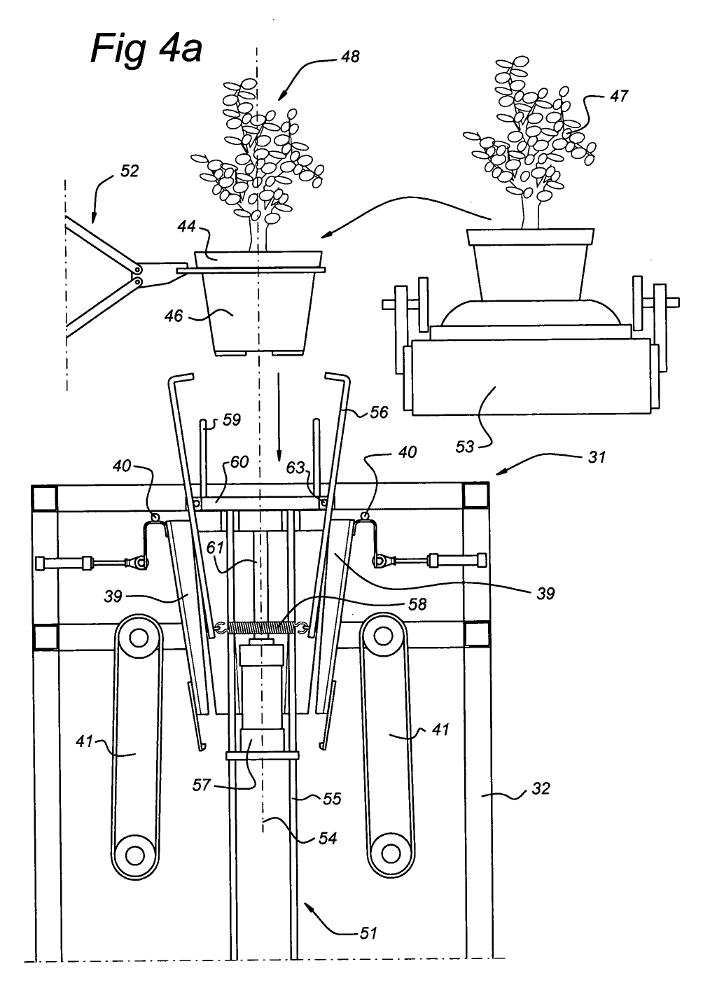

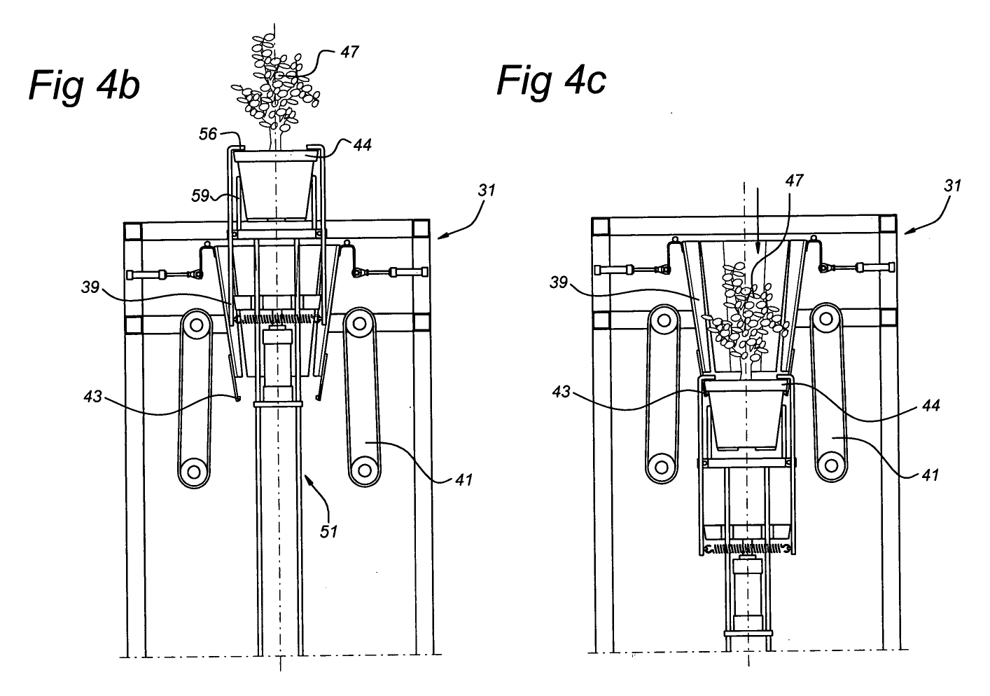

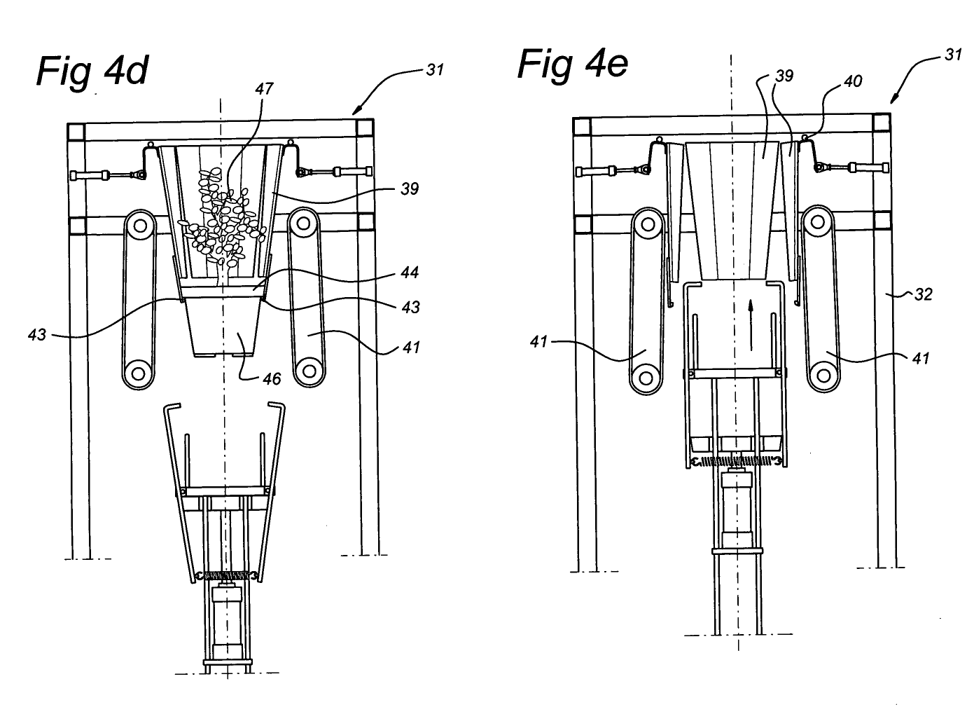

FIGS. 4a-e show a variant of the device shown on the basis of FIGS. 1-3.

In the figures the device according to the present invention is indicated in its entirety by 1. This consists of a fixed frame 2. A store for sleeves is indicated by 3. A remover 4 is arranged in a position opposite the top of the sleeves. This consists of a rod 5 that is provided with a suction head at the end. This rod 5 can move back and forth in the cylinder 7 in the direction of arrow 6. A vacuum source 8 is connected to the suction head. There are four spoons 9 or shell parts, each of which is able to pivot about a pivot 10. An applicator belt that can be flipped in and out is indicated by 11 (FIG. 2). For the sake of clarity this has been omitted in FIG. 1.

Each spoon 9 or shell part is provided with an extension or finger 12. This is provided with a ridge 13 close to the end.

The aim is to provide a pot plant 18 with a sleeve 20 using this device. The pot plant 18 comprises a plant 17 and a pot 16 with rim 14.

The various features will be explained with reference to FIG. 3. In the position shown in FIG. 3a the spoons 9 have been moved towards one another and in this way delimit a desired space that corresponds to at least part of the exterior of the plant 17. In this position the pot plant 18 is introduced in the direction of arrow 19. During this operation the fingers 12, i.e. ridges 13, extend inwards to such an extent that the bottom of the pot is able to pass freely but that the pot is stopped at the rim 14. That is to say the rim 14 is clamped from below and from above by ridges 13 and 22, respectively. The plant 17 is not touched or is barely touched by the spoons 9. The applicator belt 11 is in a position away from the spoons 9. A sleeve is then extracted from the store 3 with the suction head fitted on rod 5. Because the “rear” of the sleeve clings to the store, the front edge is pulled away from the rear edge of the sleeve. This can also be promoted by blowing in air via blow pipe 15. As a result positioning of the open sleeve below the pot 16 of the pot plant 18, shown diagrammatically in FIG. 3a, is obtained. However, it is also possible to present the sleeves in a different way, for example separately from a stack.

The sleeve is then moved upwards in some way or other. This is shown in FIG. 3b. Moving completely upwards is promoted by flipping applicator belt 11 in and turning said belt. Optionally it is possible to bring the sleeve 20 upwards in another way. The sleeve 20 can optionally be provided with a base. With this arrangement the pot is retained by the ridges 22. In the position shown in FIG. 3c the sleeve is in the correct position with respect to the pot. However, the assembly of spoons 9 is between the plant and the sleeve. Removal of the pot plant from the spoons without contact with and/or damage to the plant takes place as shown in FIGS. 3d-e. In the first stage the spoons are moved outwards a little, as a result of which the ridge 13 releases the rim 14. As a result the plant can move downwards over a short distance. When it moves further downwards each of the spoons 9 can move further outwards as a result of the larger gap created by the ever widening part of the sleeve, so that the final position according to FIG. 3e is obtained. In this way when each of the spoons pivots about pivot 10 the plant can move downwards without substantial contact with the spoons and/or the fingers 12 and can be transported, provided with the sleeve, to a removal station.

It will be understood that it is possible to provide the assembly of spoons with any other shape. It will also be understood that it is not necessary to define a continuous surface with the spoons.

A further embodiment of the device described above is shown in FIGS. 4a-e. This is indicated in its entirety by 31 and consists of a fixed frame 32. Sleeves are supplied in the manner described on the basis of FIGS. 1-3. The pot plant is indicated in its entirety by 48 and consists of a pot 46 with rim 44 and a plant that protrudes above the pot and is indicated by 47.

In this embodiment there are likewise spoons 39 for delimiting a space between them for accommodating the pot plant including the plant. As in the previous embodiment, spoons 39 or shell parts can be pivoted about a pivot 40. 41 indicates the belts for moving the sleeves upwards around the spoons or shell parts 39.

In this embodiment now shown there are first movement means 51 and second movement means 52. As shown diagrammatically in FIG. 4a, the second movement means 52 function to move the pot plant from a conveyor 53 to a position above the space delimited by the spoons 39. In the embodiment described above on the basis of FIGS. 1-3 the pot plant was moved into the space between the spoons through of gravity. If, however, the plant extends (radially) to an appreciable extent with respect to the shape of the pot plant and/or parts of the plant have a particularly high coefficient of friction, it can be the case that the pot does not move downwards to a sufficient extent. If the pot is allowed to drop into the space from a greater height there is the risk of damage.

Therefore, according to the present invention the use of first movement means 51 in Assembly with the second movement means that have just been described is proposed. These first movement means 51 consist of a part 55 that is able to reciprocate along the longitudinal axis 54. This is provided with opposing gripper tongs 56, which are connected to a cylinder 57. Furthermore, these are coupled to one another via a spring 58. Instead of the spring 58, cylinder 57 can be made double-acting. An accomodation for the flowerpot 46 is delimited between clamping parts 59 arranged on a support 60 that is connected to the plunger 61 of cylinder 58. The support 60 is provided with pivots 63 close to the ends for fixing the gripper tongs 56. The mutual position of plunger 61 with respect to cylinder 58, that is to say the mutual position of support 60 with respect to cylinder 58, determines the angle of the gripper tongs 56.

It can be seen from FIG. 4b that when the pot plant 48 is introduced from the second movement means plunger 61 executes a return movement in cylinder 58. As a result the gripper tongs 56 grip around the top of the rim of pot 44. After it has been gripped firmly, the pot plant is pulled downwards through the space delimited between the spoons 39, as shown in FIG. 4c. When the position shown in FIG. 4d is reached, where the rim 44 of the pot bears on the ridges 43, plunger 61 is again moved out with respect to cylinder 58, as a result of which gripper tongs 56 move upwards and outwards. This (moving tongs outwards) is possible because these are able to move in the gap between the fingers 12. In the position in which the gripper tongs 56 have moved outwards part 55 then moves downwards. In this position the spoons can be passed freely.

Finally, in FIG. 4e the position is shown after the pot plant provided with the sleeve has been removed when the first movement means are moved back again.

By means of the present invention it is possible to place a sleeve around an assembly of spoons in an accurate, well-defined manner. Because there are at least three and preferably four or even five or more spoons, passage of the pot plant after fitting of the sleeve is not impeded.

In this description, plant is understood both to be a plant in a pot and without a pot, such as a bunch of flowers.

Using the present invention it is possible to process larger numbers of pot plants per hour than in the case of manual processing. This number can be even further increased by installing the various components in a carousel arrangement, as a result of which, using a number of groups of spoons, the pot plants can be continually moved past stations, such as a station for the introduction of the pot plants, a station for the provision of a sleeve, a station for moving the sleeves upwards over the spoons and a removal station.

These and further variants will be immediately apparent to those skilled in the art after reading the above description and fall within the scope of the appended claims.

1. A device for fitting a sleeve around a plant, comprising guide shells for accommodating a plant between them and taking a sleeve outside them, which shells can be moved relative to one another between a closed position in which these delimit a space for accepting a plant from a first direction from the introduction end of the shells and an open position for releasing the plant in a second direction from the release end of the shells when fitting said sleeve, wherein said second direction is in the extension of said first direction, there being at least three shells that can be moved relative to one another, wherein the device has transport means for moving a sleeve over said shells in a direction opposed to said first and second direction.

2. The device as claimed in claim 1, wherein said shells are fitted in a pivoting manner and the pivots are positioned close to the introduction end of said shells.

3. The device as claimed in claim 1, wherein said shells delimit a (truncated) conical space.

4. The device as claimed in claim 1, wherein gripper fingers are arranged on each of said shells in the extension of said shells at the release end, the free end of said gripper fingers being designed to grip a plant pot.

5. The device as claimed in claim 4, wherein said transport means comprise rollers placed against the outer surface of said shells.

6. The device as claimed in claim 1, having a store for sleeves, removal means for taking a sleeve from said store and opening means for opening a sleeve for fitting on said shells.

7. The device as claimed in claim 1, constructed as a carousel, with a stationary feed station for said pot plants and a stationary removal station for said pot plants, wherein said shell parts can be rotated as a whole between them.

8. The device as claimed in claim 7, having a stationary station for dispensing sleeves.

9. The device as claimed in claim 1 having first gripper/movement means comprising a gripper part and a displacement part that moves the gripper part, constructed such that said gripper part can be moved into a position within said shells and wherein said gripper part is designed to grip a pot.

10. The device as claimed in claim 9, wherein said gripper part comprises gripper tongs that can be moved with respect to one another.

11. The device as claimed in claim 10, having second gripper/movement means for grasping pot plants and transferring them into the space delimited between said shells.

12. A combination comprising a pot plant with a pot and a plant as well as a device for fitting a sleeve around them, which device comprises guide shells for accommodating the pot plant between them and taking a sleeve outside them, which shells can be moved relative to one another between a closed position in which these delimit a space for accepting the pot plant from a first direction from the introduction end of the shells and an open position for releasing the pot plant in a second direction from the release end of the shells when fitting said sleeve, wherein said second direction is in the extension of said first direction, wherein the height of said shells is greater than or equal to the height of the plant protruding from the pot in the position in which the pot plant has been arranged in said device.

13. A method for fitting a sleeve around a plant in a pot, comprising introducing and enclosing said plant in a space between shells, fitting a sleeve over said shells and simultaneously removing said plant and said sleeve from said shells, wherein the plant is a pot plant, the pot of which is clamped during fitting of the sleeve.

14. The method as claimed in claim 13, wherein fitting of said sleeve comprises grasping said sleeve and moving it over said shells.

15. The method as claimed in claim 13, wherein taking up said pot plant within said shells comprises gripping said pot plant and moving it in said first direction into the space.
